(19) United States
(12) Patent Application Publication
(10) Pub. No.: US 2010/0308116 A1
(43) Pub. Date: Dec. 9, 2010

(54) DATA COLLECTION APPARATUS AND PORTABLE DATA COLLECTION DEVICE

(75) Inventors: Andrea Sani, Ferrara (IT); Claudio Mazzone, Crespellano (IT)

Correspondence Address: DUANE MORRIS LLP - Philadelphia;IP DEPARTMENT, 30 SOUTH 17TH STREET, PHILADELPHIA, PA, 19103-4196, US

(73) Assignee: DATALOGIC SCANNING GROUP S.R.L., Lippo di Calderara di Reno, BO (IT)

(21) Appl. No.: 12/743,254

(22) PCT Filed: Nov. 19, 2007
(86) PCT No.: PCT/IB2007/003539

§ 371 Date: Aug. 10, 2010

(51) Int. Cl. G06K 7/01; F16M 13/00; H01F 7/00

(52) U.S. Cl. 235/472.01; 235/439; 248/346.03

(57) ABSTRACT

A data collection apparatus includes a portable data collection device, a supporting base arranged for receiving the portable data collection device and connecting means arranged for removably retaining the portable data collection device in the supporting base, the connecting means including magnetic connecting means.

The invention relates to a data collection apparatus comprising a portable data collection device, a supporting base arranged for receiving the portable data collection device and a connecting device for removably connecting the portable data collection device to the supporting base, or to a supporting element in general. The portable data collection device may comprise a portable device for the acquisition and possibly the management of data which is connected by cable to a computer for supplying and exchanging data, or a portable device for the acquisition and possibly the management of data which is battery-operated and intended for interacting with a base for recharging the battery and/or exchanging data. The portable data collection device may be a PDT (portable data terminal) i.e. a portable terminal for the automatic or manual acquisition of data, or in general a portable automatic identification device such as a portable reader of optical information or a portable reader of encoded information stored in a transponder (generally part of a “tag” or label).

Reading apparatuses are known comprising an optical information reading device, for example a device for reading barcodes, or tags that can be grasped by an operator and is thus portable. The reading apparatus further comprises a supporting base arranged for receiving the reading device, when not in use. The supporting base may comprise a battery-charging device that supplies batteries with which the reading device is provided. Alternatively, if the battery-charging device is contained in the reading device, the supporting base comprises a supply circuit for the battery charger. The reading device may therefore assume a use configuration, in which it is grasped by the user to acquire the optical information or tag, and a rest configuration, in which it is received and retained by the supporting base so that the batteries can be charged, if necessary.

The reading device can be connected to the supporting base by a radio-frequency device. The supporting base receives from the reading device the read information and transmits the information via traditional interfaces to a computer host. The reading apparatus may comprise connecting devices arranged for retaining the reading device in the supporting base so as to maintain the reading device in the rest configuration, i.e. to prevent the reading device from disengaging accidentally from the supporting base. The connecting devices may comprise mechanical hooking devices.

The connecting devices are provided particularly in reading apparatuses destined to be mechanically stressed, for example inasmuch as they are subjected to blows and/or vibrations.

In particular, the connecting devices are provided in reading apparatuses that are installed on forklift trucks or handling means in general, such as vehicles used in warehouses or other industrial environments.

In this case, the connecting devices can be so shaped as to connect the reading device not only to the supporting base, but also to a supporting element provided in the forklift truck, or in another vehicle, so that the user can put away the reading device whilst driving the aforesaid forklift truck, or the aforesaid other vehicle. In particular, the connecting devices can comprise hooking elements. In this case, the batteries of the reading device are not charged whilst the reading device is received by the supporting element, but only when the reading device is received by the supporting base.

A drawback of known reading apparatuses is that, before removing the reading device from the supporting base, it is necessary to operate the connecting devices in such a manner that the connecting devices free the reading device. In many cases, in order to remove the reading device from the supporting base, a user has to use both hands. The user in fact grasps with one hand the reading device and with the other hand operates the connecting devices.

This is very inconvenient for the user as he has to interrupt, at least for a certain time, the activity to which he is assigned.

Connecting devices are known that may be operated with a single hand. However, such devices are mechanically very complex and are therefore difficult to make and are very costly. These connecting devices, owing to the complexity thereof, are rather delicate and are therefore easily subject to breakage.

An object of the invention is to improve known data collection apparatuses.

A further object is to obtain a data collection apparatus provided with a portable data collection device, for example a PDT (portable data terminal), i.e. a portable terminal for the automatic or manual acquisition of data or, in general, a portable automatic identification device such as a portable reader of optical information or a portable reader of encoded information stored in a tag, which is firmly couplable with a supporting element in a rest configuration and which is easily separable from the supporting element for passing to an operating configuration.

In a first aspect of the invention, there is provided a portable data collection device, comprising connecting means for removably retaining said portable data collection device in a supporting element, characterised in that said connecting means comprises magnetic connecting means.

The supporting element may comprise a supporting base suitable for receiving and retaining the portable data collection device. In particular, the supporting base may comprise a battery-charging device for charging at least one electric battery of the portable data collection device, or a supplying device for supplying a battery-charging device provided in the data collection device.

In a second aspect of the invention, there is provided a supporting base of a data collection apparatus suitable for receiving a portable data collection device, comprising connecting means arranged for removably retaining said portable data collection device in said supporting base, characterised in that said connecting means comprises magnetic connecting means.

In a third aspect of the invention, there is provided a data collection apparatus, comprising a portable data collection device, a supporting base arranged for receiving said portable data collection device and connecting means arranged for removably retaining said portable data collection device in said supporting base, characterised in that said connecting means comprises magnetic connecting means.

Owing to these aspects of the invention, it is possible to obtain a data collection apparatus, for example a PDT (portable data terminal) i.e. a portable terminal for the automatic or manual acquisition of data or, in general, a portable automatic identification device such as a portable reader of optical information or a portable reader of information stored in tags, in which the magnetic connecting means prevents the portable data collection device from disengaging in an non-intentional manner from the supporting base, and at the same time does not hinder the removal of the portable data collection device from the supporting base by a user. In particular, the user can remove the portable data collection device from the supporting base using only one hand. This enables the user not to have to necessarily interrupt an activity to which he is assigned. For example, an operator assigned to driving a forklift truck, or another vehicle, can insert a portable data-collection device, for example a reading device into, and/or remove the reading device from, the supporting base, whilst he is driving the aforesaid forklift truck, or the aforesaid other vehicle.

The magnetic connecting means, in fact, is much easier to operate than known mechanical connecting devices. Further, the magnetic connecting means is much simpler to make than known mechanical connecting devices. In addition, the magnetic connecting means is less costly than known mechanical connecting devices.

In an embodiment, the magnetic connecting means is provided in portions of the portable data collection device intended for interacting with corresponding further portions of the supporting base.

Owing to the magnetic connecting means the portable data collection device can be firmly fixed not only to the supporting base, but also to any supporting element having magnetic properties—for example a metal structure—or bearing an element having magnetic properties and intended for cooperating with the magnetic connecting means.

The portable data collection device, for example, can be firmly fixed to, and easily removed from, a metal frame that forms part of the bodywork of a forklift truck, or of another vehicle.

In an embodiment, the magnetic connecting means can comprise a permanent magnet on the portable data collection device and a corresponding ferromagnetic element on the supporting base, or a permanent magnet on the supporting base and a ferromagnetic element on the portable data collection device, or a first permanent magnet on the portable data collection device and a second permanent magnet on the supporting base, the first permanent magnet and the second permanent magnet being positioned in such a way that a portion of the first permanent magnet and a further portion of the second permanent magnet intended for mutually interacting have polarities that are such as to attract one another.

In a further embodiment, the magnetic connecting means can comprise an electromagnet. The electromagnet can be controlled directly by a user, for example by a switch, or by a sensor, for example a optic proximity sensor.

The invention can be better understood and implemented with reference to the attached drawings, which illustrate some embodiments by way of non-limiting example, in which;

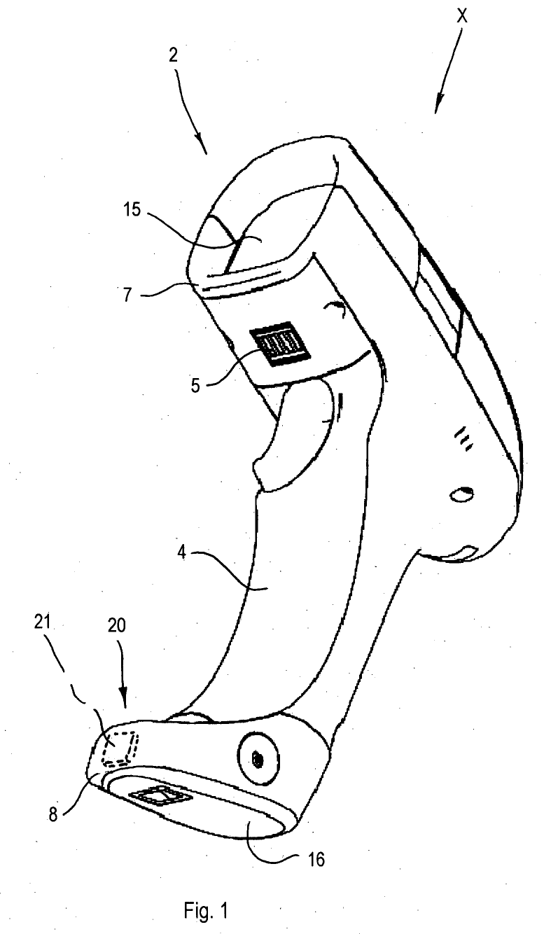

FIG. 1 is a perspective view of a portable reading device;

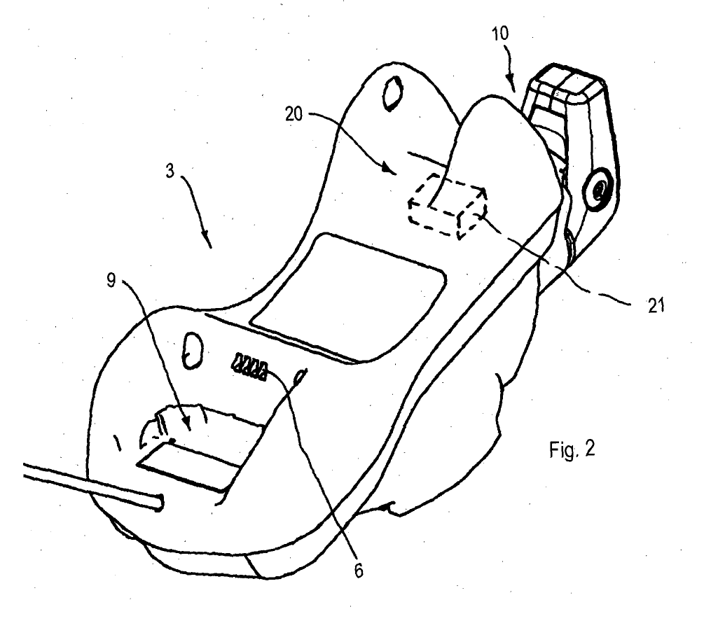

FIG. 2 is a perspective view of a supporting base of a reading apparatus;

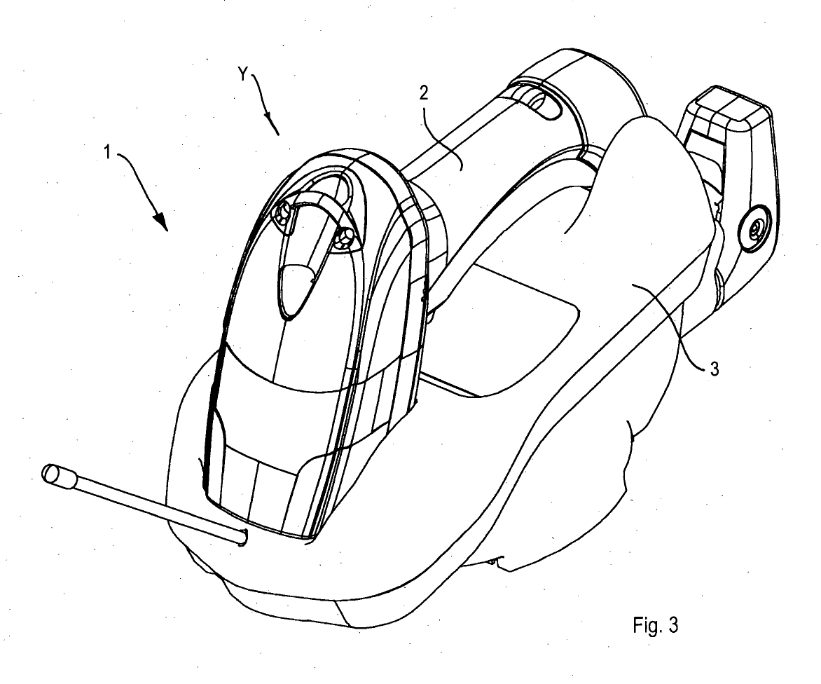

FIG. 3 is a perspective view of the reading device in FIG. 1 and of the supporting base in FIG. 2 mutually coupled;

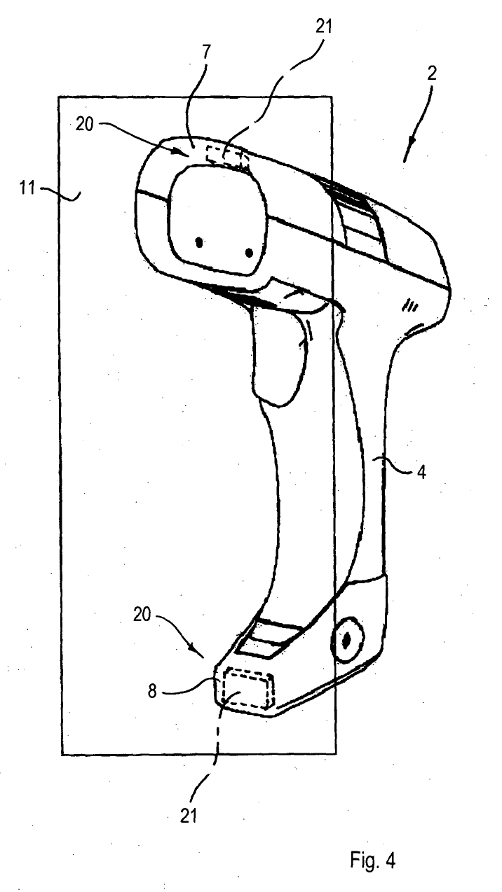

FIG. 4 is a perspective view of the reading device in FIG. 1 coupled with a supporting surface;

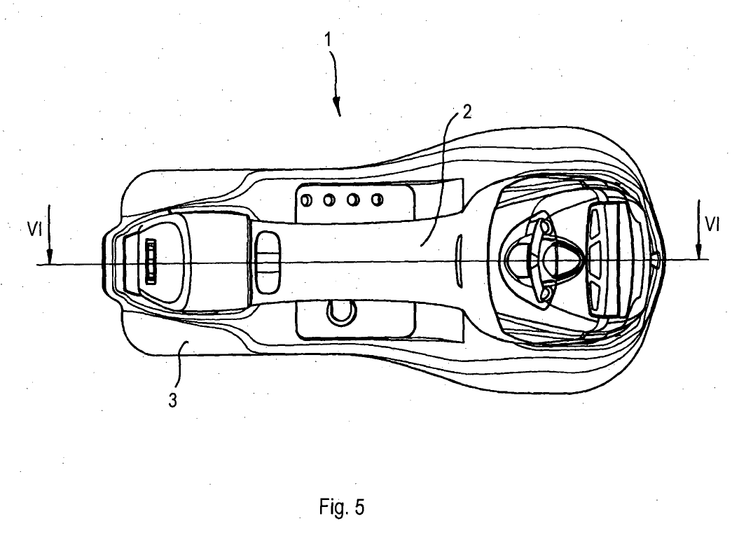

FIG. 5 is a plan view of a portable reading device;

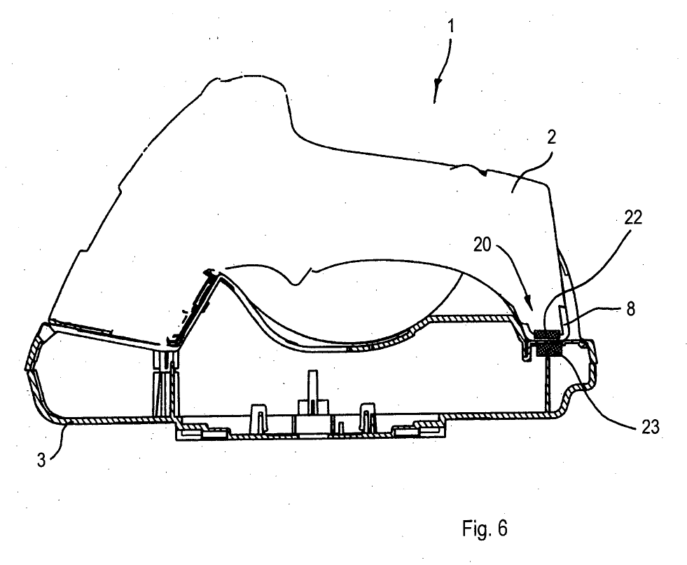

FIG. 6 is a section taken along a plane VI-VI in FIG. 5;

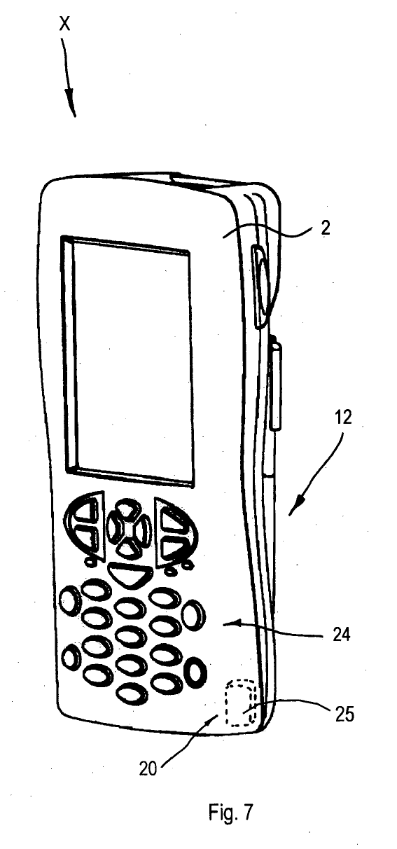

FIG. 7 is a perspective view of a portable data collection terminal;

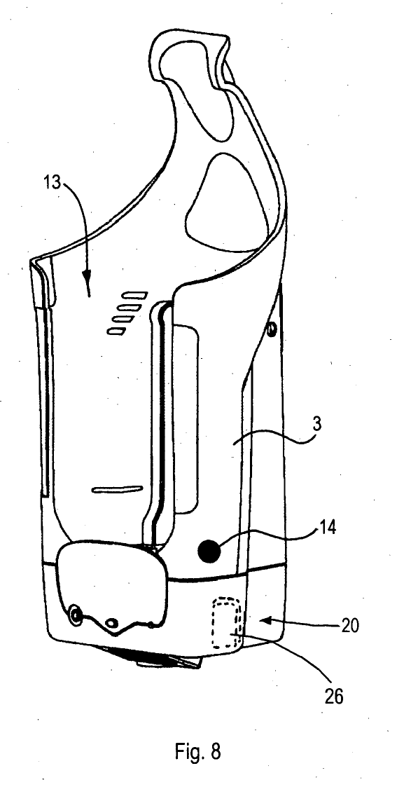

FIG. 8 is a perspective view of a supporting base intended for receiving the portable data collection terminal in FIG. 7;

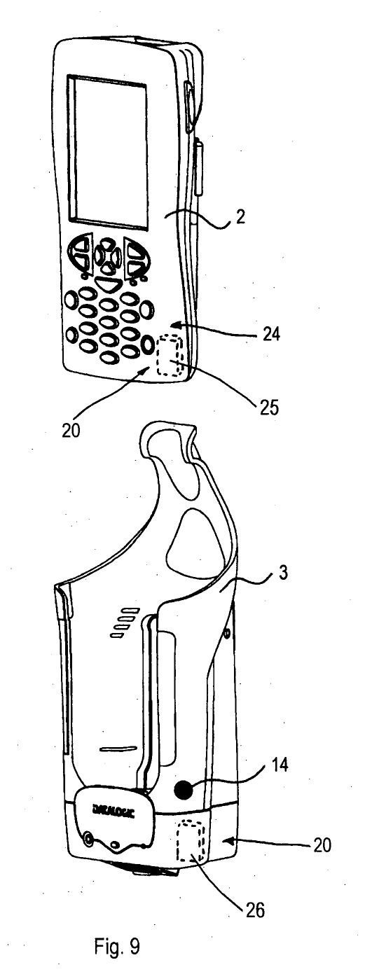

FIG. 9 is a perspective view of the portable data collection terminal in FIG. 7 and of the supporting base in FIG. 8 in a step that precedes positioning of the portable data collection terminal in the supporting base;

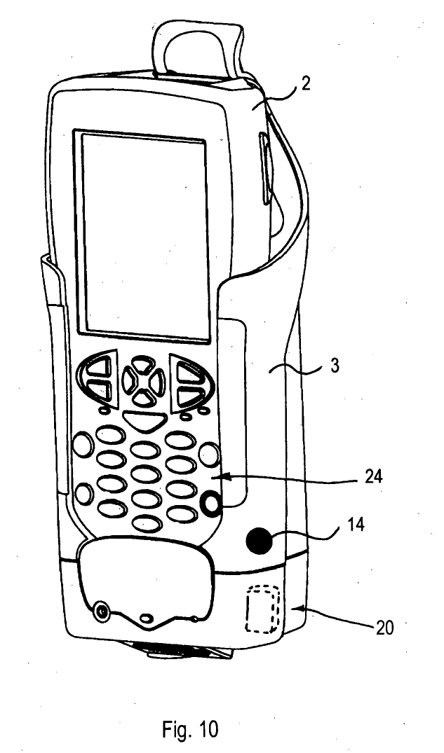

FIG. 10 is a perspective view of the portable terminal in FIG. 7 and of the supporting base of FIG. 8 mutually coupled.

With reference to FIGS. 1 to 6, there is shown a reading apparatus 1 comprising a portable reading device 2 of the gun type and a supporting base 3 (cradle).

Alternatively, there can be provided a data collection apparatus in general comprising a portable data collection device.

The expression “data collection device” is used in the present description and in the claims to indicate any device suitable for acquiring data associated with objects, such as the identifying data thereof, or in manual mode by an operator (for example by keying in using a portable terminal) or in automatic mode (by reading optical information or tags associated with said objects). The portable data collection device may be a PDT (portable data terminal) i.e. a portable terminal for acquiring data manually or automatically, or, in general, a device for automatically identifying and acquiring data such as a portable reader of optical information or a portable reader of information stored in tags.

The reading apparatus 1 is in particular a reading apparatus for reading optical information and/or information that is encoded and stored in tags. As is known, the tags can be read and/or written by radio-frequency reading and/or writing devices (better known as RFID readers).

The expression “optical information” is used in the present description to indicate any graphic representation having the function of storing coded or non coded information. A particular example of optical information consists of linear or two-dimensional linear optical codes in which the information is encoded by suitable combinations of elements of prefixed shape, for example squares, rectangles or hexagons, of a dark colour (normally black) separated by clear elements (spaces, normally white), such as barcodes, stacked codes and two-dimensional codes in general, colour codes, etc. The term “optical information” further comprises, more in general, also other graphic shapes, including printed characters (letters, numbers, etc) and particular patterns (such as, for example stamps, logos, signatures, fingerprints, etc). The term “optical information” comprises graphic representations that are detectable along the entire wavelength comprised between infrared and ultraviolet, and thus not only in the visible light range.

In the present description the expression “portable reading device” means a portable device that is capable of reading tags and/or optical information, by means of a plurality of possible acquisition techniques.

For example, acquisition may be by illuminating a subject, collecting, by an appropriate optical receiving apparatus, light diffused by the subject on a sensor consisting of an array of photosensitive elements of linear or matrix type, for example of CCD or CMOS type, and generating an image signal by means of electronics integrated in or associated with the sensor. The generated image signal, in analogue or digital form, can then be processed in the same device or in a separate image-processing device.

Typically, in encoded optical reading devices such as barcodes and optical codes in general, the image signal in digital form is decoded to extract the information contents of the code.

Devices of this type are known as linear or matrix television cameras or cameras, and in the case of reading optical information, are also known as “imager” type readers.

According to another technique, acquisition can occur by illuminating a subject by scanning one or more laser beams, collecting the light diffused or reflected by the subject onto one or more photodiodes by an optical receiving device and generating, by dedicated electronics, an electric image signal representing the diffusion/reflection of each point of the subject hit by the laser beam during scanning. This signal is then processed, and, in particular for reading devices for reading encoded optical information, is digitised and decoded. Devices of this type are generally known as “laser scanners”. Instead of capturing an image with a single simultaneous acquisition for all the photosensitive elements (“parallel”), as in television cameras and in “imager” readers, in “laser scanners” the image of the subject during scanning is captured in a sequential manner instant by instant (“serially”).

For reading tags, on the other hand, the reading device generates an electromagnetic field at an excitation frequency for the transponder contained in the tag that, when it has entered this field, transmits to the reading device a signal containing the code stored in the transponder. A similar method is used for writing information in the transponder.

The reading device 2 can assume an operating configuration X, shown in FIG. 1, in which the reading device 2 is separated from the supporting base 3 to read, for example, an optical code or a tag, and a rest configuration Y, shown in FIG. 3, in which the reading device 2 engages the supporting base 3.

In the operating configuration X, a gripping portion 4 of the reading device 2 can be grasped by a user, so that the reading device 2 is taken to a position that is suitable for reading the optical code or the tag code associated with the object.

The reading device 2 comprises electric contact elements 5. The supporting base 3 comprises further electric contact elements 6, intended for interacting with the electric contact elements 5.

In an embodiment, the supporting base 3 comprises a battery-charging device for charging a battery provided in the reading device 2.

In another embodiment, the supporting base 3 comprises a supplying device for supplying a battery charger provided in the reading device 2 and arranged for charging a battery of the reading device 2.

In the rest configuration Y, the electric contact elements 5 of the reading device 2 interact with the further electric contact elements 6 of the supporting base 3, such that the battery charger provided in the supporting base 3, or in the reading device 2, and supplied by the contact with the supporting base 3, charges a battery with which the reading device 2 is equipped.

By using magnetic coupling between the reading device 2 and the supporting base 3, as disclosed below, greater reliability of the electric connection between the electric contact elements 5 and the further electric contact elements is ensured in the event of blows and/or vibrations, for example in installations on forklift trucks, or other vehicular applications.

In the rest configuration Y, a first coupling portion 7 and a second coupling portion 8 of the reading device 2 are received, respectively, in a first cavity 9 and in a second cavity 10 of the supporting base 3.

The first coupling portion 7 may surround—at least partially—a window of the reading device 2 for the entry/exit of the reading light.

The second coupling portion 8 can be defined in a foot 16 of the reading device 2.

The reading device 2 and the supporting base 3 can be interconnected by a radio-frequency device such that the data collected by the reading device 2 through reading the optical information or the information contained in the tag can be transmitted to a processing unit associated with the supporting base 3, such as a computer host.

The reading apparatus 1 further comprises magnetic connecting means 20 arranged for mutually removably connecting the reading device 2 and the supporting base 3 so as to retain the reading device 2 in the supporting base 3 and maintain the reading device 2 in the rest configuration Y.

The magnetic connecting means 20 can be provided at the first coupling portion 7 and at the first cavity 9 and/or at the second coupling portion 8 and at the second cavity 10.

In an embodiment, the magnetic connecting means 20 comprises permanent magnets 21 provided in the reading device 2 at the first coupling portion 7 and/or at the second coupling portion 8 and ferromagnetic elements provided in the supporting base 3 at walls that bound the first cavity 9 and/or the second cavity 10.

In another embodiment, the magnetic connecting means comprises permanent magnets provided in the supporting base 3 at walls that bound the first cavity 9 and/or the second cavity 10 and ferromagnetic elements provided in the reading device 2 at the first coupling portion 7 and/or at the second coupling portion 8.

In a further embodiment, the magnetic connecting means comprises first permanent magnets 22 provided in the reading device 2 at the first coupling portion 7 and/or at the second coupling portion 8 and second permanent magnets 23 provided in the supporting base 3 at walls that bound the first cavity 9 and/or the second cavity 10. In this case, the first permanent magnets 22 and the second permanent magnets 23 are positioned in such a way that a zone of the first permanent magnets 22 having a certain polarity faces a further zone of the second permanent magnets 23 having a polarity opposite said polarity in such a way that the first permanent magnets 22 and the second permanent magnets 23 attract one another when the reading device 2 is near the supporting base 3.

Owing to the magnetic connecting means 20, the reading device 2 is maintained firmly fixed to the supporting base 3 in the rest configuration Y.

As a result, the reading device 2 does not separate from the supporting base 3 even if the reading apparatus 1 is subjected to stress of significant intensity, such as vibrations or blows.

The reading apparatus 1 can then be used also for applications in which it is subjected to great stress, for example on forklift trucks.

Furthermore, owing to the magnetic connecting means 20 the reading device 2 can be easily removed from the supporting base 3. In particular, a user can move the reading device 2 from the rest configuration Y to the operating configuration X using just one hand.

As shown in FIG. 4, owing to the magnetic connecting means 20, the reading device 2 can be firmly removably fixed not only to the supporting base 3, but also to any supporting surface 11.

In an embodiment, the magnetic connecting means 20 comprises permanent magnets 21 provided in the reading device 2 at the first coupling portion 7 and/or at the second coupling portion 8, whilst the supporting surface 11 is made of (or comprises at least in part) ferromagnetic material.

In this case, owing to the magnetic connecting means 20, the reading device 2 can be fixed to objects of various types, for example the bodywork of a forklift truck, or of another vehicle.

In another embodiment, the magnetic connecting means 20 comprises ferromagnetic elements provided in the reading device 2 at the first coupling portion 7 and/or at the second coupling portion 8, whilst the supporting surface 11 is made of (or comprises at least in part) a permanent magnet.

With reference to FIGS. 7 to 10, a data collection apparatus 1 is shown made according to a version and comprising a data collection device 2. The data collection device 2 is a portable terminal for acquiring data by reading optical information and/or tags that are associated with an object and/or by manual inputting by an operator, for example by a keyboard 24.

The data collection apparatus 1 is provided with magnetic connecting means 20.

In an embodiment, the magnetic connecting means 20 can be of the previously disclosed type.

In another embodiment, the magnetic connecting means 20 comprises magnetic elements 25 provided in the data collection device 2 at a coupling portion 12 and electromagnets 26 provided in the supporting base 3 at walls that bound a cavity 13 arranged for receiving the coupling portion 12.

The electromagnets 26 are controlled electrically by the supporting base 3.

There is further provided an optic proximity sensor 14 that activates the electromagnets 26 so that the electromagnets 26 retain the magnetic elements provided in the data collection device 2 so as to maintain the data collection device 2 in the rest configuration Y. When the hand of a user approaches the data collection device 2 and grasps a gripping portion, the optic proximity sensor 14 deactivates the electromagnets 26, which release the data collection device 2.

Also in this case, the user can remove the data collection device 2 from the supporting base 3 using only one hand.

Alternatively to the optic proximity sensor 14 there can be provided a sensor of different type or a switch for manually controlling the activation or deactivation of the electromagnets.

The aforesaid sensor or the aforesaid switch can be provided both on the supporting base 3 and on the data collection device 2.

In an embodiment that is not shown, the magnetic connecting means comprises at least one electromagnet provided in the data collection device 2 and at least one magnetic element provided in the supporting base 3.

1. A portable data collection device, comprising connecting means for removably retaining said portable data collection device in a supporting element wherein the connecting means comprises magnetic connecting means.

2. (canceled)

3. The portable data collection device according to claim 1, wherein said supporting element comprises a supporting base arranged for receiving said portable data collection device.

4. (canceled)

5. (canceled)

6. The portable data collection device according to claim 3, wherein said magnetic connecting means is provided at a coupling portion of said portable data collection device suitable for being received in a cavity of said supporting base.

7. (canceled)

8. The portable data collection device according to claim 6, wherein said magnetic connecting means is provided at a further coupling portion of said portable data collection device suitable for being received in a further cavity of said supporting base.

9. (canceled)

10. The portable data collection device according to claim 1, wherein said magnetic connecting means comprises at least one permanent magnet.

11. The portable data collection device according to claim 1, wherein said magnetic connecting means comprises at least one ferromagnetic element.

12. The portable data collection device according to claim 1, wherein said magnetic connecting means comprises at least one electromagnet.

13. The portable data collection device according to claim 12, and further comprising sensor means arranged for controlling said at least one electromagnet.

14. The portable data collection device according to claim 13, wherein said sensor means comprises an optic proximity sensor.

15. The portable data collection device according to claim 12, and further comprising a switch operatable by a user for controlling said at least one electromagnet.

16. A supporting base of a data collection apparatus suitable for receiving a portable data collection device, comprising connecting means arranged for removably retaining said portable data collection device in said supporting base, wherein said connecting means comprises magnetic connecting means.

17. (canceled)

18. (canceled)

19. (canceled)

20. The supporting base according to claim 16, wherein said magnetic connecting means is provided at a cavity of said supporting base suitable for receiving a coupling portion of said portable data collection device.

21. (canceled)

22. The supporting base according to claim 20, wherein said magnetic connecting means is provided at a further cavity of said supporting base suitable for receiving a further coupling portion of said portable data collection device.

23. (canceled)

24. The supporting base according to claim 16, wherein said magnetic connecting means comprises at least one permanent magnet.

25. The supporting base according to claim 16, wherein said magnetic connecting means comprises at least one ferromagnetic element.

26. The supporting base according to claim 16, wherein said magnetic connecting means comprises at least one electromagnet.

27. The supporting base according to claim 26, and further comprising sensor means arranged for controlling said at least one electromagnet.

28. The supporting base according to claim 27, wherein said sensor means comprises an optic proximity sensor.

29. The supporting base according to claim 26, and further comprising a switch operatable by a user for controlling said at least one electromagnet.

30. A data collection apparatus, comprising a portable data collection device, a supporting base arranged for receiving said portable data collection device and connecting means arranged for removably retaining said portable data collection device in said supporting base, wherein said connecting means comprises magnetic connecting means.

31. (canceled)

32. (canceled)

33. (canceled)

34. The data collection apparatus according to claim 30, wherein said magnetic connecting means is provided at a coupling portion of said portable data collection device and at a cavity of said supporting base, said coupling portion being arranged for being received in said cavity.

35. (canceled)

36. The data collection apparatus according to claim 34, wherein said magnetic connecting means is provided at a further coupling portion of said portable data collection device and at a further cavity of said supporting base, said further coupling portion being arranged for being received in said further cavity.

37. (canceled)

38. (canceled)

39. (canceled)

40. (canceled)

41. The data collection apparatus according to claim 30, wherein said magnetic connecting means comprises at least one electromagnet provided in said portable data collection device and at least one magnetic element provided in said supporting base.

42. The data collection apparatus according to claim 30, wherein said magnetic connecting means comprises at least one magnetic element provided in said portable data collection device and at least one electromagnet provided in said supporting base.

43. The data collection apparatus according to claim 42, and further comprising sensor means arranged for controlling said at least one electromagnet.

44. The data collection apparatus according to claim 43, wherein said sensor means comprises an optic proximity sensor.

45. The data collection apparatus according to claim 42, and further comprising a switch operatable by a user for controlling said at least one electromagnet.
